(19) United States
(12) Patent Application Publication
(10) Pub. No.: US 2021/0387423 A1
(43) Pub. Date: Dec. 16, 2021

(54) BONDING DEVICE

(71) Applicant: TRIPLE WIN TECHNOLOGY(SHENZHEN) CO.LTD., Shenzhen (CN)

(72) Inventors: WEN-CHIN TSAI, Shenzhen (CN); ZHE-ZHI LIANG, New Taipei (TW); CONG ZHU, Shenzhen (CN)

(21) Appl. No.: 16/990,144

(22) Filed: Aug. 11, 2020

(30) Foreign Application Priority Data
Jun. 16, 2020 (CN) 202010550750.1

(51) Int. Cl. B29C 65/14; B29C 65/00

(52) U.S. Cl. CPC B29C 65/1412; B29C 66/0342

(57) ABSTRACT

A bonding device includes a body defining a cavity, a controller provided in the cavity, an intake device provided on the body and configured to fill gas into the cavity under the control of the controller, an exhaust device provided on the body and configured to remove the gas from the cavity under the control of the controller, a heating device provided in the cavity and configured to heat the gas in the cavity under the control of the controller, and a cooling device provided on a side of the cavity and configured to dissipate heat from the cavity. The intake device and the exhaust device are in communication with the cavity. The heating device, the intake device, and the exhaust device are electrically coupled to the controller.

### FIELD

The subject matter herein generally relates to a bonding device, and more particularly to a bonding device for bonding components of an electronic device.

### BACKGROUND

The temperature during normal operation of camera components of most camera devices (such as mobile phones) is generally higher than the workshop temperature during assembly and testing of the camera components. Therefore, the camera devices may not meet specification requirements in actual use, resulting in low yield.

### BRIEF DESCRIPTION OF THE DRAWINGS

Implementations of the present disclosure will now be described, by way of embodiments, with reference to the attached figures.

FIG. 1 is a schematic cross-sectional diagram of a bonding device according to an embodiment.

FIG. 2 is another schematic cross-sectional diagram of the laminating device from another perspective.

FIG. 3 is a schematic structural diagram of a cooling device of the bonding device according to an embodiment.

FIG. 4 is a schematic structural diagram of the cooling device according to another embodiment.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

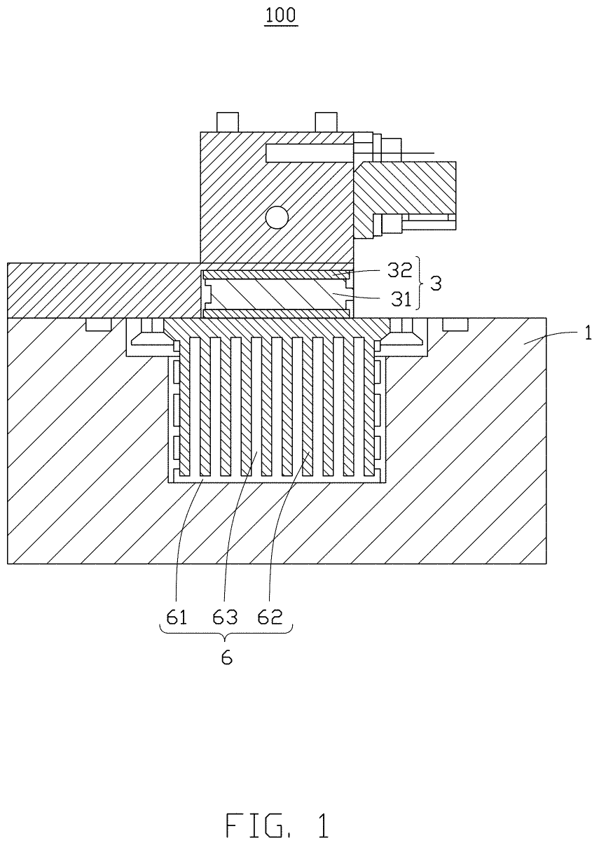

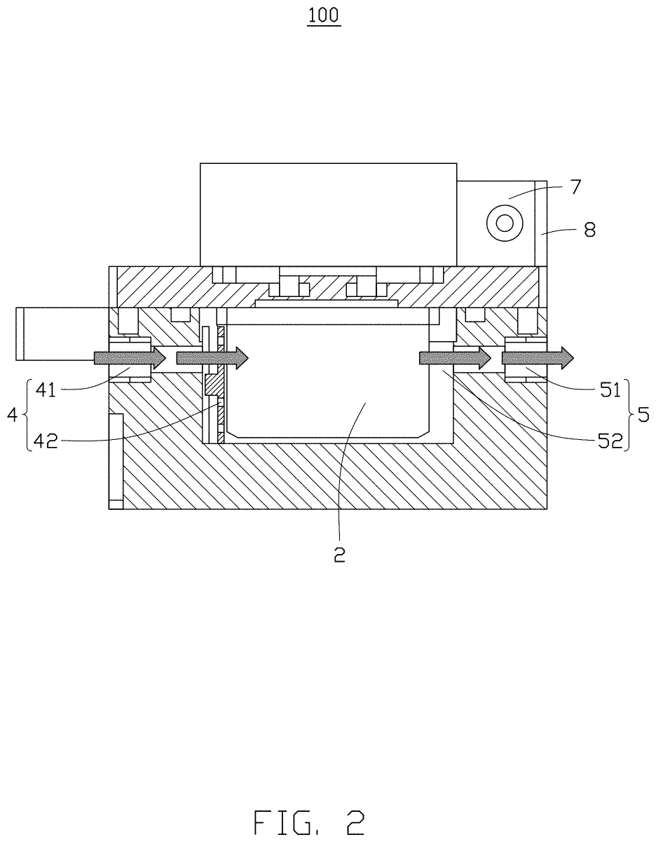

Referring to FIG. 1 and FIG. 2, a bonding device 100 includes a body 1, a cavity 2 defined in the body 1 for accommodating a bonding station, a heating device 3 provided in the cavity 2, an intake device 4 provided on the body 1, an exhaust device 5 provided on the body 1, a cooling device 6 provided on a wall of the cavity 2, a temperature sensor (not shown) provided in the cavity 2, and a controller 7 provided in the cavity 2. The intake device 4 and the exhaust device 5 are in communication with the cavity 2. The heating device 3, the intake device 4, the exhaust device 5, and the temperature sensor are electrically connected to the controller 7. The intake device 4 is used for filling gas into the cavity 2 under the control of the controller 7. The exhaust device 5 is used for removing gas from the cavity 2 under the control of the controller 7. The heating device 3 is used for heating the gas in the cavity 2 under the control of the controller 7. The cooling device 6 is used for cooling the gas in the cavity 2. In another embodiment, the heating device 3 and the cooling device 6 can be added to a body of a bonding machine for improving a test accuracy of a product.

The body 1 includes a cover plate (not shown) for closing the cavity 2. Products are laminated and assembled in the cavity 2.

As shown in FIG. 1, the heating device 3 is arranged on an upper part of the cavity 2 and includes a bracket 31 and at least one heating lamp 32 arranged on the bracket 31. The number of the at least one heating lamp 32 can be set according to the actual size of the cavity 2. In one embodiment, a plurality of heating lamps 32 can be arranged side-by-side for improving the heating efficiency and making the temperature in the cavity 2 more uniform. In one embodiment, the heating lamps 32 are infrared lamps, which have a high heating efficiency and simple structure. The heating lamps 32 are connected to the controller 7. The controller 7 adjusts the temperature in the cavity 2 by controlling the number of the heating lamps 32 to turn on and the power of the heating lamps 32.

As shown in FIG. 2, the intake device 4 includes an intake pipe 41 provided on the body 1, an intake port 42 provided on a wall of the cavity 2, and an intake pipe 41 provided A gas compression device (not shown) and a gas flow controller (not shown) far away from the intake port 42, the gas compression device fills the gas through the intake pipe 41 and the intake port 42 To the cavity 2. The gas entering the cavity 2 is heated by the heating lamp 32 to provide a suitable working environment temperature for the bonding station. The gas flow controller accurately controls the intake volume and intake rate of the air.

The exhaust device 5 includes an exhaust pipe 51 provided on the body 1 and an exhaust port 52 provided on a wall of the cavity 2. An exhaust device (not shown) is provided on an end of the exhaust pipe 51 away from the exhaust port 52 for exhausting the gas in the cavity 2 through the exhaust port 52 and the exhaust pipe 51.

In one embodiment, the intake device 4 and the exhaust device 5 are respectively arranged on opposite sides of the cavity 2. The direction of gas flow is shown by arrows in FIG. 2, and gas flow in the cavity 2 is uniform to prevent dead ends caused by uneven heating.

In one embodiment, the gas filled into the cavity 2 is an inert gas, such as nitrogen for preventing the bonding station and the product from being oxidized. In another embodiment, air is filled into the cavity 2.

In one embodiment, both the intake port 42 and the exhaust port 52 are provided with dust-proof nets or waterproof and breathable membranes. The dust-proof net can prevent dust from entering the cavity 2, and the waterproof and breathable membrane can prevent moisture and dust from entering the cavity 2, thereby prolonging the service life of the bonding station.

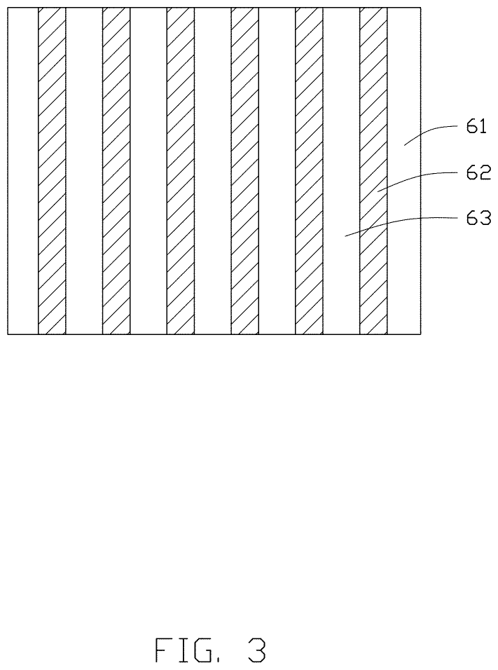

As shown in FIG. 3, the cooling device 6 is arranged on an outer wall of the cavity 2 to dissipate heat. The cooling device 6 includes a cooling plate 61, a plurality of fins 62 provided on the cooling plate 61, and cooling channel 63 provided between each two adjacent fins 62. In one embodiment, the cooling plate 61 and the fins 62 are made of aluminum. Aluminum has high thermal conductivity, fast cooling efficiency, and low price, which is beneficial to reducing equipment costs. By adding the cooling device 6, the temperature of the outer wall of the cavity 2 and surrounding components can be effectively reduced, so that the corresponding components are not damaged due to excessive heat.

A plurality of temperature sensors can be provided in the cavity 2 for sensing the temperature in different locations in the cavity 2. The controller 7 can control the heating device 3 according to the sensed temperatures in the cavity 2 for making the temperature in the cavity 2 uniform. In one embodiment, the temperature in the cavity 2 is set at 35° C.-42° C. By performing the bonding work under this temperature environment, the yield of the laminated products can be effectively improved.

The bonding device 100 further includes a display 8 electrically connected to the controller 7 and the temperature sensor. The display 8 displays the temperatures sensed by the temperature sensors in the cavity 2.

The bonding device 100 is compared to a bonding device in the related art for bonding a mobile phone camera, and the products obtained by the two devices are tested. The results of testing are shown in Tables 1-3.

TABLE 1

| | Standard | Experimental | Present | Related |
|---|---|---|---|---|
| Test type | value | result | disclosure | art |
| Average spot | <1.9 mm | Largest value | 1.59 | 1.78 |
| size (before | | Least value | 1.51 | 1.49 |
| UV curing) | | Average value | 1.54 | 1.56 |
| | | Standard deviation | 0.03 | 0.09 |
| | | Cpk | 4.44 | 1.28 |
| Average spot | <1.9 mm | Largest value | 1.62 | 1.70 |
| size (after | | Least value | 1.54 | 1.52 |
| UV curing) | | Average value | 1.57 | 1.57 |
| | | Standard deviation | 0.03 | 0.06 |
| | | Cpk | 4.11 | 1.73 |
| Average spot | <1.9 mm | Largest value | 1.61 | 1.68 |
| size (after | | Least value | 1.53 | 1.52 |
| thermal curing) | | Average value | 1.57 | 1.57 |
| | | Standard deviation | 0.03 | 0.06 |
| | | Cpk | 4.22 | 1.87 |
| Average spot | <0.05 mm | Largest value | 0.03 | 0.08 |
| size increment | | Least value | 0.02 | 0.02 |
| (after UV | | Average value | 0.03 | 0.03 |
| curing) | | Standard deviation | 0.00 | 0.02 |
| | | Cpk | 5.91 | 0.31 |
| Average spot | <0.1 mm | Largest value | 0.03 | 0.10 |
| size increment | | Least value | 0.02 | 0.03 |
| (after thermal | | Average value | 0.02 | 0.04 |
| curing) | | Standard deviation | 0.00 | 0.02 |
| | | Cpk | 8.91 | 0.93 |

TABLE 2

| | Standard | | Experimental | Present | Related |
|---|---|---|---|---|---|
| Test type | value | | result | disclosure | art |
| Z-axis rotation | <2 | mrad | Largest value | 0.12 | 0.36 |
| angle (before | | | Least value | −0.39 | −0.52 |
| UV curing) | | | Average value | −0.02 | −0.03 |
| | | | Standard deviation | 0.17 | 0.32 |
| | | | Cpk | 3.88 | 2.14 |
| Z-axis rotation | <2 | mrad | Largest value | 0.46 | 0.46 |
| angle (after | | | Least value | −0.39 | −0.29 |
| UV curing) | | | Average value | −0.02 | 0.02 |
| | | | Standard deviation | 0.25 | 0.27 |
| | | | Cpk | 2.71 | 2.44 |
| Z-axis rotation | <2 | mrad | Largest value | 0.27 | 0.44 |
| angle (after | | | Least value | −0.41 | −0.42 |
| UV curing + | | | Average value | 0.01 | 0.04 |
| after thermal | | | Standard deviation | 2.83 | 2.05 |
| curing) | | | Cpk | 2.83 | 2.05 |
| Spot separation | >2.8 | mrad | Largest value | 4.74 | 4.73 |
| angle (before | | | Least value | 4.15 | 3.30 |
| UV curing) | | | Average value | 4.43 | 4.26 |
| | | | Standard deviation | 0.23 | 0.41 |
| | | | Cpk | 2.37 | 1.19 |
| Spot separation | >2.8 | mrad | Largest value | 4.71 | 4.72 |
| angle (after | | | Least value | 4.13 | 3.81 |
| UV curing) | | | Average value | 4.44 | 4.33 |
| | | | Standard deviation | 0.22 | 0.29 |
| | | | Cpk | 2.44 | 1.76 |

TABLE 3

| | Standard | Experimental | Present | Related |
|---|---|---|---|---|
| Test type | value | result | disclosure | art |
| Spot separation | >2.8 mrad | Largest value | 4.69 | 4.72 |
| angle (after UV | | Least value | 4.15 | 3.78 |
| curing + after | | Average value | 4.44 | 4.32 |
| thermal curing) | | Standard deviation | 0.22 | 0.29 |
| | | Cpk | 2.47 | 1.74 |
| Z-axis rotation | <1 mrad | Largest value | 0.39 | 0.50 |
| angle change | | Least value | 0.06 | 0.01 |
| value (after UV | | Average value | 0.15 | 0.24 |
| curing) | | Standard deviation | 0.10 | 0.18 |
| | | Cpk | 2.85 | 1.40 |
| Z-axis rotation | <1 mrad | Largest value | 0.26 | 0.44 |
| angle change | | Least value | 0.05 | 0.03 |
| value (after UV | | Average value | 0.16 | 0.13 |
| curing + after | | Standard deviation | 0.09 | 0.12 |
| thermal curing) | | Cpk | 3.27 | 2.37 |
| Spot separation | <1 mrad | Largest value | 0.05 | 0.51 |
| angle change | | Least value | 0.01 | 0.00 |
| value (after UV | | Average value | 0.02 | 0.07 |
| curing) | | Standard deviation | 0.01 | 0.16 |
| | | Cpk | 29.51 | 1.97 |
| Spot separation | <1 mrad | Largest value | 0.05 | 0.48 |
| angle change | | Least value | 0.00 | 0.01 |
| value (after UV | | Average value | 0.01 | 0.06 |
| curing + after | | Standard deviation | 0.02 | 0.15 |
| thermal curing) | | Cpk | 21.52 | 2.13 |

It can be seen from the test results in Tables 1-3 that the CPK of the product bonded using the bonding device 100 is better than the CPK of the product bonded using the related art device without a heating function. Thus, a difference between the product used by the end client and the product tested is relatively small, and the product yield of the bonding device 100 is higher.

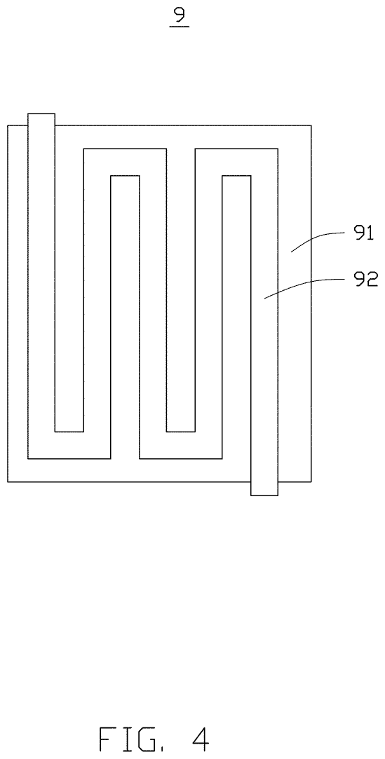

FIG. 4 shows a cooling device 9 according to another embodiment. The cooling device 9 includes a cooling plate 91 and a cooling pipe 92 provided on the cooling plate 91. The cooling pipe 92 is used for accommodating a cooling medium, such as water. The cooling pipe 92 is arranged in a snaking pattern on the cooling plate 91. The cooling plate 91 is made of aluminum, and the cooling tube 92 is made of stainless steel. In one embodiment, the walls of the cavity 2 and the surrounding components are cooled by the water to achieve a higher cooling efficiency. The cooling pipe 92 arranged in the snaking pattern improves a cooling efficiency and space utilization.

Compared with the related art, the bonding device 100 has the following beneficial effects:

1. It can effectively control the environmental temperature variables. In the bonding process, the heating device makes the production end bonding environment consistent with the customer use end environment, and the product performance is more stable, which effectively improves the product quality and improves the product yield.

2. The temperature is controlled by injecting gas into the cavity, so that the temperature of the bonding station is more uniform, no local overheating occurs, and the heating effect is improved.

3. Less changes are required on the traditional bonding machine without special equipment, which can effectively reduce equipment costs.

4. It can meet the requirements of the original manufacturing process for equipment accuracy.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A bonding device comprising:
a body defining a cavity for receiving a bonding station;
a heating device provided in the cavity;
an intake device provided on the body;
an exhaust device provided on the body;
a cooling device provided on a side of the cavity; wherein:
the intake device and the exhaust device are in communication with the cavity;
the intake device is configured to fill gas into the cavity;
the exhaust device is configured to remove the gas from the cavity; and
the heating device is configured to heat the gas in the cavity.

2. The bonding device of claim 1, wherein:
the heating device comprises a bracket and at least one heating lamp;
the bracket is provided on an upper part of the cavity.

3. The bonding device of claim 2, wherein:
the at least one heating lamp is an infrared lamp.

4. The bonding device of claim 1, wherein:
the intake device comprises an intake pipe and an intake port;
the intake pipe is provided on the body;
the intake port is provided on a side of the cavity;

5. The bonding device of claim 4, wherein:
the exhaust device comprises an exhaust pipe and an exhaust port;
the exhaust pipe is provided on the body; and
the exhaust port is provided on a side of the cavity.

6. The bonding device of claim 5, wherein:
the intake device and the exhaust device are provided on opposite sides of the cavity.

7. The bonding device of claim 1, wherein:
the cooling device comprises a cooling plate and a plurality of fins; and
the plurality of fins is provided on the cooling plate.

8. The bonding device of claim 7, wherein:
a channel is provided between each two adjacent fins.

9. The bonding device of claim 1, wherein:
the cooling device comprises a cooling plate and a cooling pipe provided on the cooling plate; and
the cooling pipe accommodates a cooling medium.

10. The bonding device of claim 1, further comprising a display configured to display parameters of the cavity.

11. The bonding device of claim 10, wherein:
the parameters of the cavity comprise a temperature inside the cavity.

12. A bonding device comprising:
a body defining a cavity;
a controller provided in the cavity;
an intake device provided on the body and configured to fill gas into the cavity under the control of the controller;
an exhaust device provided on the body and configured to remove the gas from the cavity under the control of the controller;
a heating device provided in the cavity and configured to heat the gas in the cavity under the control of the controller; and
a cooling device provided on a side of the cavity and configured to dissipate heat from the cavity; wherein:
the intake device and the exhaust device are in communication with the cavity; and
the heating device, the intake device, and the exhaust device are electrically coupled to the controller.
